(19) United States
(12) Patent Application Publication
(10) Pub. No.: US 2002/0126602 A1
(43) Pub. Date: Sep. 12, 2002

(54) Recording on a multilayer record carrier using feed forward power control

(75) Inventor: Roel Van Woudenberg, Eindhoven (NL)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/989,249

(22) Filed: Nov. 20, 2001

(30) Foreign Application Priority Data
Jan. 11, 2001 (EP) 01200062.6

(51) Int. Cl. G11B 7/125

(52) U.S. Cl. 369/47.51

(57) ABSTRACT

The present invention relates to a multilayer record carrier, a recording apparatus and a method of recording on such a multilayer record carrier, wherein a difference in a transmission property of an upper information layer (6) is detected, and a corrected power value is used for recording on a lower information layer (8) at positions where the difference has been detected. The corrected power value is determined on the basis of the detected difference or a specification provided on the multilayer record carrier. Thereby, the recording power level or margin can thus be maintained during the recording on the lower information layer (8), that is, even in cases where the recording is effected through header areas (H) or gap portions (RO, RI) in the upper information layer (6).

The present invention relates to a recording apparatus and to a method of recording on a multilayer record carrier such as a recordable optical disk suitable to be scanned by a single scanning device and provided with at least two substantially parallel information layers, wherein data is written in units of blocks on tracks of the at least two information layers, and to a multilayer record carrier such as a dual layer optical disk.

Optical data storage systems, such as optical disk drives, allow storage of large quantities of data on an optical medium. The data is accessed by focussing a laser beam onto the recording layer of the medium and then detecting the reflected light beam. In reversible or rewritable phase-change systems, optical media with two stable phases are used. A data bit is stored on the media by converting a small local area to one stable phase. The data bit can be erased by reverting the written area back to the starting phase. The starting phase is typically a crystalline phase and the laser beam writes data by locally converting the material in the data layer to a stable amorphous phase. This can be achieved by heating the crystalline region beyond its melting point and then cooling it quickly so that the disordered structure becomes fixed in place, resulting in an amorphous structure. The data bit can later be erased by converting the amorphous phase back to the starting crystalline phase. This is done when the amorphous region is heated and maintained at or above its crystallisation temperature, or alternatively melted and slowly cooled until the region is crystallised. The data in this type of phase change system is read by detecting changes in reflectivity between a crystalline region and an amorphous region on the optical medium.

To increase the storage capacity of an optical disk, multiple recording layer systems have been proposed. An optical disk having two or more recording layers may be accessed at different spatially separated recording layers by changing the focal position of a lens. The laser beam is transmitted through the nearer recording layer to read and write data on the farther recording layer or layers. For multiple recording layer disks it is necessary that the intermediate recording layers between the disk surface onto which the laser light is incident and the last or furthest recording layer from that surface are light-transmissive.

In (rewritable) optical recording with random access the data is usually written in units of ECC blocks (e.g. in CLV systems without headers), in fixed recording unit blocks of a fixed fraction of an ECC block, such as for example 2 kbyte or 4 kbyte of user data (e.g. in Zoned Constant Angular Velocity systems with headers where the distance between two headers is an integer multiple of these recording unit blocks), or in variable length fractions of an ECC block (e.g. in Digital Video Recording systems where the ECC block size is not an integer multiple of the distance between two headers, and writing is “simply” stopped before a header and restarted after a header with the inclusion of some segment run-in and segment run-out data to guarantee proper behaviour of the electronics). These fractions of ECC blocks are called “Recording Frames” in DVR systems and “SYNC Frames” in DVD systems. In optical record carriers with headers, the record carrier is subdivided in sectors, each sector comprising a header containing an address uniquely identifying the sector and a recording unit block in which user data, preferably protected by an error detection and correction code (ECC), is recorded.

In DVR systems a Zoned Constant Angular Velocity (ZCAV) system is used. In such systems the capacity of a sector is not constant across the disk. The linear density is approximately constant and the number of tracks per zone is constant, but the length of a track increases with a factor of 2.4 from the inner to the outer radius of the disc, while the number of headers per revolution is constant. Thus, the number of bits between two headers increases. The DVR system and format are described in T. Narahara et al, “Optical Disc system for Digital Video Recording”, Techn. Digest ISOM/ODS (MD1) Jul. 11-15, 1999, Kauai Hi., SPIE Vol. 3864 (1999), 50-52, and Jpn. J. Appl. Phys. 39 Pt. 1 No. 2B (2000), 912-919, and in K. Schep et al, “Format description and evaluation of the 22.5 GB DVR disc”, Techn. Digest ISOM 2000 (September 2000).

When data is written in such systems, the newly written data has to be linked a controlled way with the data that is already present in to guarantee the validity of both the already present data as well as the newly written data. For example, the new block should not be written over the user data in the already present block. This is ensured by introducing a gap between the end of the present data block and the start of the new data block. Moreover, gaps are also provided at the header areas. Just after (segment run-in) and before (segment run-out) the header area, the groove is not yet written with phase change data. In the DVR system, the segment run-in starts with a gap before the data is actually written and the segment run-out ends with a gap just before the header.

In DVR systems the gaps may have a length of typically about 150 μm while the diameter of the beam in the upper layer is about 40 μm when writing on the lower layer. Thus, gaps in upper layers interfere with the writing on a lower layer. The influence of the gaps increases when the gaps are at the same angular position in neighbouring tracks, e.g. in CLV or ZCAV systems when an integer number of ECC blocks fits almost exactly on one or an integer number of circumferences.

The difference in the transmittivity or transmission between the header areas and (crystalline) non-written groove regions or gaps is in general only marginal due to the fact that the refractive indices of the cover layer (or substrate) on one side of the upper layer and the spacer on the other side is only small (typically less than or equal to 0.1, e.g. cover with n=1.6 and spacer with n=1.5). However, a main issue is the difference between written and non-written areas, there the header areas present a major problem. The header areas behave as gaps with respect to their transmittivity. Hence, they constitute a major problem due to their frequent appearance, i.e. eight times per circumference in DVR systems and even more frequently in for example, DVD-RAM systems with headers.

The header areas and gaps have a reduced transmittivity as compared to the written recording section. Due to the random orientation of the upper information layer, the header areas of the upper information layer may be located over a recording or writing sector of the lower information layer, such that the transmission property of the upper information layer differs within the header areas and gaps. Furthermore, displacements of the upper information layer with respect to a lower information layer may result from unroundness, eccentricity (decentering of the center of the spiral track with respect to the central hole) and angular differences. The decentering of the spiral track with respect to the central hole is introduced mainly in the molding step of the disk mastering and replication process.

In dual or multilayer systems, the lower layer is written or recorded while a significant part of the laser beam passes through the gaps or header areas of the upper layer or layers. Thus, when information or data has been recorded on the upper information layer, the transmission properties or transmission characteristics of the upper layer differ in dependence of whether or not the laser beam passes through written areas, gaps, or header areas. In case of a random access recording, i.e. a fragmented recording, on the upper information layer, an irregular or random recording pattern is provided which is combined with the header areas and gap portions so as to form a complex transmittivity or shadowing pattern. The difference in the transmittivity of the upper layer in the written and the non-written state results from the fact that amorphous portions, i.e. marks, are introduced in the crystalline upper layer during writing, the transmittivity being higher in the amorphous portions than in the crystalline surrounding. In K. Kurokawa et al, Techn. Digest ISOM/ODS'99 (SPIE Vol. 3864), 197-199, a dual layer disk is proposed which has the following parameters for the upper layer:

| | |
|---|---|
| Transmittivity in the non-written state: | T(non-written) = 45% |
| Transmittivity in the written state: | T(written) = 55% |

Thus, the transmittivity or transmission T of the non-written state is lower than that of the written state. When writing on the lower information layer, passing through a non-written area on the upper information layer requires a higher incident power P_{inc} on the disk than passing through a written area to achieve the same recording power P_{rec} on the lower information layer. This is expressed by the following equation:

P_{rec}=P_{inc}·T(upper layer)

For example, when an incident power P_{inc}=14 mW is required during recording through a written upper layer, the incident power during recording through a non-written upper layer amounts to P_{inc}=17.1 mW as is derived from the above formula using the parameter values found by Kurokawa et al.:

P_{rec}=P_{inc,written}·T(written)=P_{inc,non-written}·T(non-written),

P_{inc,non-written}=P_{inc,written}·T(written)/T(non-written

P_{inc,non-written})=14mW·(0.55/0.45)=17.1 mW.

In the above example, the recording power required when recording through a written upper layer amounts to only 82% of the recording power required for recording through a non-written upper layer. Thus, the use of a recording power of 14 mW would result in an under-power of 18% when recording through a non-written area while a recording power of 17.1 mW would result in an over-power of 18% when recording through a written area. However, these value in general are not within the allowed power margin specified for optical recording systems. Typically this allowed power margin is in the range of from −10% to +15%.

It is an object of the present invention to provide a method and an apparatus for recording on a multilayer record carrier which enables a reduction of the effects of the differences in the transmission properties on the recording operation can be reduced.

This object is achieved by a recording method as claimed in claim 1 and by a recording apparatus as claimed in claim 18. Accordingly, a corrected value for the recording power is used at positions where the upper layer “throws a shadow” on the lower layer due to a change in the transmission or transmittivity state of the upper layer, i.e. at positions where data is not recorded or non-written in the upper information layer or at positions where a header area is arranged in the upper information layer. A correct power level with an adequate margin can thus be maintained during writing in the lower information layer so as to ensure proper recording.

The difference in the transmission property may be detected when the at least one recording layer contains recording data. For example, when the transmittivity of the upper information layer, i.e. the layer in-between the radiation source and the lower information layer, is lower in non-written or empty areas, a corrected higher recording or writing power is used to write correctly in the lower information layer, that is, as compared to the case where data has already been written in the upper information layer.

The corrected value may be determined by measuring the reflection level difference of an empty track in the other information layer when the recording is effected through a non-recorded area and a recorded area of the at least one information layer. This may be done, for example, during an initial Optimum Power Calibration (OPC) procedure when trail recordings are performed. The corrected value can then be determined on the basis of the measured reflection level differences. As an alternative, the corrected value may be determined by reading a corresponding specification provided on said record carrier. A suitable corrected value for the recording power is thus determined in advance so as to be used in cases where recording is effected through a non-written portion of the upper information layer.

Preferably, a power correction procedure provided in the recording apparatus, for example a Running OPC procedure, is used for correcting the recording power according to the corrected value. In particular, the corrected value may be used as a pre-set value for the power correction procedure at the position where the difference has been detected. The dynamic range which is usually limited for protection against mis-adaptations of the recording powers to unacceptable levels can thus be increased at pre-detected positions.

An angular offset between header areas of the at least two information layers may be determined by measuring differences in the reflection level in the other information layer that are caused by the header areas in the at least one information layer at a predetermined measuring point. The positions of the other header areas are derived from the angular offset thus determined. Now the corrected value is used at all header positions. Furthermore, a second measurement at another predetermined measuring point located at another radius of the record carrier, may be performed so as to account for possible decentering of one of the at least two information layers.

In an embodiment of the method and apparatus according to the invention the difference is obtained from a transmission map indicating recorded portions of said at least one information layer. This transmission map may be combined with positions of header areas or gap portions. The transmission map may then be corrected on the basis of a displacement determined between said at least two information layers. A map indicating regions of the upper layer where the recording power has to be corrected can thus be obtained. Based on this map, the recording power can be controlled during the recording operation. In particular, the transmission map can be derived from a table of contents of said at least one information layer, or, alternatively, from a pre-scanning operation such as a quick scan operation in which only every N tracks are scanned so as to find locations which are affected by the transmission state of the at least one information layer.

The corrected value is, in general, a higher power value since the header portions or non-written portions lead, in general, to a reduced transmittivity of the upper layer as compared to written portions. However, corrected values having a lower power value may also occur.

It is a further object of the invention to provide a multilayer record carrier for use in a method and an apparatus according to the invention.

This object is achieved by means of a record carrier as claimed in claim 25. A suitable corrected or correction value or a correction factor for the recording or writing power to be used in non-written portions or header areas can thus be derived from the record carrier by a corresponding reading or detection operation, e.g. by reading the value from the so-called Disc Information data, i.e. embossed pits or modulated wobble data containing disc parameters, such as write power, erase power, bias power, writing speed, pulse width, needed for writing, and the like. Thus a determination of the corrected value on the basis of the detected reflection level difference is no longer required and processing power and time can be saved.

The present invention will be described in greater detail hereinafter on the basis of a preferred embodiment and with reference to the accompanying drawings, in which

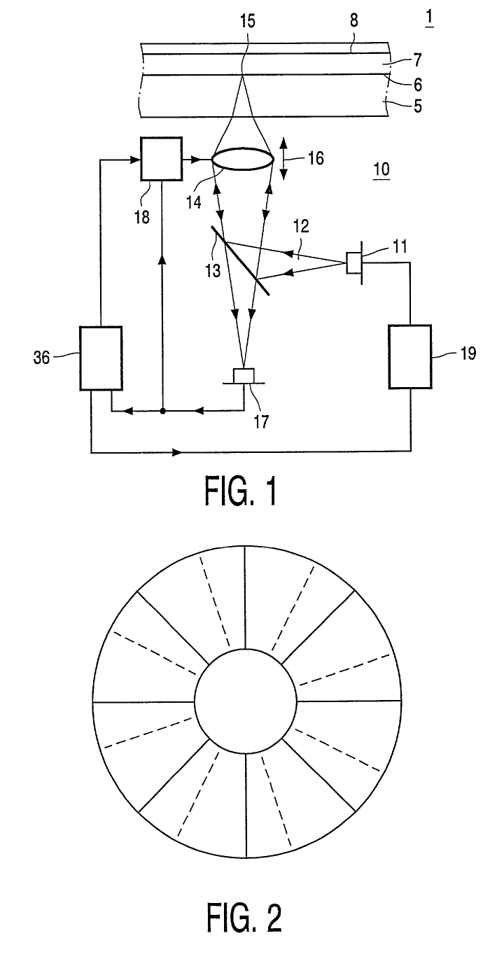

FIG. 1 shows a cross section of a dual layer optical disk and a block diagram of a recording unit according to a preferred embodiment of the present invention,

FIG. 2 shows a header layout in a dual layer optical disk,

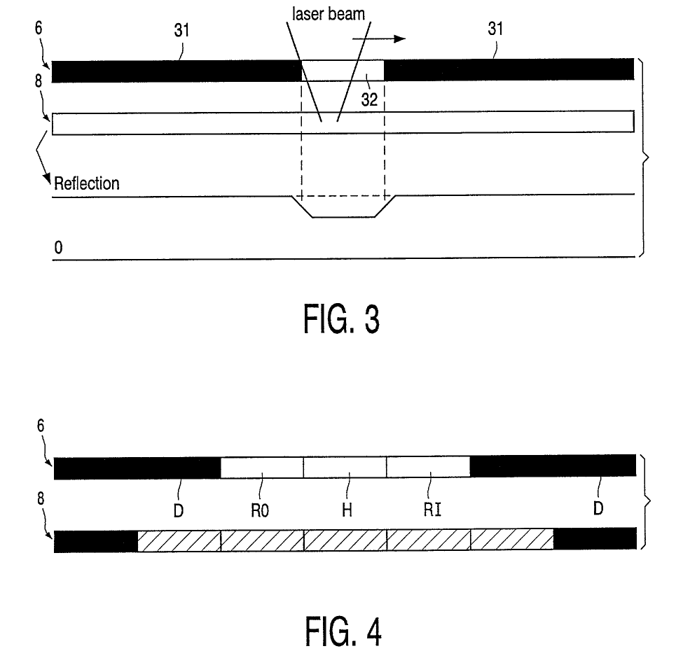

FIG. 3 shows a non-written area in a written upper information layer and a graph of the level of light reflected from a lower information layer due to the transmission through the upper layer, and

FIG. 4 shows a lower layer data area influenced by a header area in an upper information layer.

The preferred embodiment will now be described on the basis of a dual layer optical disk system, the format of the dual layer disk being based on the single layer disk format as described in T. Narahara et al in “Optical Disc system for Digital Video Recording”, Techn. Digest ISOMIODS (MD1) Jul. 11-15, 1999, Kauai Hi., SPIE Vol. 3864 (1999), 50-52, and in Jpn. J. Appl. Phys. 39 Pt. 1 No. 2B (2000), 912-919.

FIG. 1 shows a cross-section of a dual layer optical disk 1 and a recording unit 10 for performing an optical scanning operation so as to write information into the optical disk 1. The optical disk 1 has a transparent substrate 5 provided with a first information layer 6 and a second information layer 8 arranged substantially parallel thereto and separated by a transparent spacer layer 7. Although only two information layers are shown in this embodiment of the optical disk 1, the number of information layers may be more than two. The recording unit 10 comprises a radiation source 11, for example a diode laser, which generates a radiation beam 12 with a predetermined recording or writing power. The radiation beam is formed to a focussing spot 15 via a beam splitter 13, for example a semi-transparent plate, and a lens system 14, for example an objective lens. The focussing spot 15 can be placed on any desired information layer 6,8 by moving the objective lens 14 along its optical axis, as is denoted by the arrow 16. Since the first information layer 6 is partially transmissive, the radiation beam can be focussed through this layer on the second information layer 8. By rotating the optical disk 1 about its center and displacing the focussing spot in a direction perpendicular to the tracks in the plane of the information layer, enables the entire information area of an information layer to be scanned by the focussing spot during a writing or reading operation. The radiation reflected by an information layer is modulated by the stored information into, for example, intensity or direction of polarisation. The reflected radiation is guided by the objective lens 14 and the beam splitter 13 towards a detection system 17 which converts the incident radiation into one or more electrical signals. One of the signals, that is the information signal, has a modulation which is related to the modulation of the reflected radiation, so that this signal represents the information which has been read. Other electric signals indicate the position of the focussing spot 15 with respect to the track to be read and the position (i.e. the angular and the radial position) of the focussing spot 15 on the record carrier. The latter signals are applied to a servo system 18 which controls the position of the objective lens 14 and hence the position of the focussing spot 15 in the plane of the information layers and perpendicular thereto in such a way that the focussing spot 15 follows the desired track in the plane of an information layer to be scanned. A control unit 36 is provided to control the servo system 18 and the writing power applied to the radiation source 11 on the basis of a level of the reflected light signal detected by the detection system 17. The control of the writing power may be performed by feedback via a driving unit 19 to the radiation source 11. The control unit 36 operates in accordance with a control program which controls the recording unit 10 so as to achieve a proper recording on the information layers 6, 8. In particular, a writing power calibration procedure, such as an initial OPC procedure for setting an initial optimum value for the writing power, and a writing power correction procedure, such as a running-OPC procedure for correcting power losses due to, for example, fingerprints and scratches on the disk surface, may be provided.

It is to be noted that the invention is also applicable to other disk structures such as, for example, a structure where the substrate serves as a rigid carrier carrying embossed information while readout is performed through a thin cover layer. Furthermore, a two-lens objective may be used instead of the single objective lens 14 shown in FIG. 1.

FIG. 2 shows a header layout in a dual layer optical disk 1. The solid header spokes correspond to headers in the upper information layer 6 and the dashed header spokes correspond to headers in the lower information layer 8. Due to an angular displacement of the headers in the two information layers 6, 8, the (solid) header spokes provided in the upper information layer 6 are located within areas through which the light beam passes during the recording on the lower information layer 8.

FIG. 3 shows a cross-section of a non-written area 32 located between two written recording sectors or grooves 31 in the upper information layer 6. The upper information layer 6 is arranged above the lower information layer 8, that is, between the radiation source 17 and the lower information layer 8. FIG. 3 also shows a corresponding reflection level measured along a radial direction of the optical disk 1. As can be gathered from the measured reflection level which corresponds to the level of light reflected from the lower information layer 8 and transmitted through the upper information layer 6, a decrease in the reflection layer occurs at an area of the lower information layer 8 which substantially corresponds to the location of the non-written area 32 in the upper information layer 6. Consequently, the presence of the non-written area 32 leads to a reduced writing or recording power margin during the writing in the lower information layer 8. This reduction in the power margin is corrected by applying a corrected control value to the driving unit 19 for driving the radiation source 11.

This corrected value could be obtained or determined by the control unit 36 on the basis of the output signal of the detection system 17. In particular, the control unit 36 is arranged to correct the power of the radiation source 11, that is, the laser power, during the writing or recording operation, correction being made in dependence on the state or transmission characteristic of the upper information layer 6. The change of the transmission characteristic due to the presence of a non-written area 32 above the lower information layer 8 requires fast correction of the radiation power of the radiation source 11. The correction could be performed by using the running OPC procedure for recording power correction which is already used in most recordable systems for the correction of power losses due to fingerprints and scratches on the surface of the optical disk 1. However, the bandwidth of the electronics for this running OPC procedure may not be large enough to correct these header effects when the transmission difference is large. Moreover, the correction factors that the running-OPC procedure can provide are possibly too small due to the fact that the running-OPC has a maximum and/or a minimum correction range so as to protect the recording system against mis-adaptations of the writing power to unacceptable power levels. Nevertheless, an improvement can be achieved by using a feed-forward power control as a pre-set for the running-OPC in detected areas of the upper information layer 6 with a reduced transmission characteristic due to the written portions (or header areas H, as will be explained later). Both the dynamic range and the speed of the running-OPC procedure can be increased thereby.

In a record carrier of the phase-change type (i.e. a record carrier where amorphous marks are recorded in a crystalline surrounding) pre-recorded header areas H comprising embossed pits constitute a significant amount of the non-written portion of the record carrier. Although the transmission in the embossed header areas may differ from that in the non-written phase-change areas, this difference is in general very marginal and header areas are therefore in general regarded as non-written areas.

The feed-forward control of the power of the radiation source 11 can be performed as follows. At the start-up, the control unit 36 determines the angular offset between the header spokes of the upper and lower information layers 6, 8 indicated in FIG. 2, for example by detecting the differences in the reflection level of the light signal reflected from the lower information layer 8 that are caused by the header area H between the written areas in the upper information layer 6. FIG. 3 shows the aperture of the writing or recording beam; an arrow above the upper information layer 6 indicates the scanning direction. When the difference in the reflection level has been detected at one location all header positions are known for the whole disk in the DVR situation when the two information layers 6, 8 are perfectly centered with respect to each other, since the headers are organised in a spoke-like layout as can be gathered from FIG. 2. To account for any possible decentering of one layer with respect to the other, a second measurement at another radius may be performed to obtain the positions of all header spokes. The control unit 36 can now set corrected recording power values at these known positions during the recording on the lower information layer 8, that is on the basis of the detected positions of the header spokes. As an alternative, a trial recording may be performed to determine the corrected value for the recording power. This trial recording may be a power calibration procedure such as the OPC procedure at the start-up.

The corrected value for the recording power may be obtained from the measured reflection level differences while using the following equation:

P₂(corrected)=sqrt[R₂(written₁)/R₂(empty₁)]·P₂(original),

where P₂(corrected) denotes the corrected value of the recording power, R₂(written₁) denotes the measured reflection level in the lower information layer 8 through a recorded or written portion in the upper information layer 6, R₂(empty₁) denotes the measured reflection level in the lower information layer 8 through a gap or header area H in the upper information layer 6, and P₂(original) denotes the original uncorrected power used for recording through a written portion of the upper information layer 6.

After the recording data has been written in the upper information layer 6 and the lower information layer 8 is to be re-written, the correction procedure has to be performed due to the fact the transmittivity of the recording sections or groove portions changes in the written or non-written state thereof. In particular, a part of the groove portions located just before and after the header area H is not written. These portions are called segment lead-in or run-in and segment lead-out or run-out areas RI and RO as indicated in FIG. 4. Further details of this recording format can be gathered from K. Schep et al, “Format description and evaluation of the 22.5 GB DVR disc”, Techn. Digest ISOM 2000 (Sept. 2000).

FIG. 4 shows a recording scheme or pattern of the upper information layer 6 and the lower information layer 8 wherein hatched portions in the lower information layer 8 are influenced by the difference in the transmission characteristic or transmittivity of the upper information layer 6. Thus, the recording power of the radiation source 11 has to be corrected during the recording in the hatched region of the lower information layer 8. As regards the power correction, the transmittivity of the upper information layer 6 changes, for example, decreases, when it is non-written or empty, such that a higher write power is needed to write correctly in the lower information layer 8 when the upper information layer 6 is empty, that is, when it contains no written data. The difference in the transmittivity of the upper information layer 6 due to written and non-written areas can be determined by measurement of the reflection level difference of an empty track in the lower information layer 8 when seen through a fully written or a fully empty upper information layer 6. The correction value determined can then be stored in the control unit 36. Alternatively, a specification indicating the required corrected or correction power value or a power correction factor can be provided as a pre-written or other marking on the optical disk 1 to be used for the recording power in the lower information layer 8 when the upper information layer 6 is fully non-written. Furthermore, the specification may indicate an additional correction or corrected value or a correction factor to be used when the header area H is located in the upper information layer and the transmission in a header area differs not marginally but significantly from the transmission in non-written phase-change areas. The specification may be included in the disc parameters of the Disc Information data provided on the disk 1 as embossed pits or modulated wobble data. Thus, in the case shown in FIG. 4, a corrected power value is used in the recording operation of the lower information layer 8 below the run-out area RO and the run-in area RI and below the header area H so as to maintain an adequate margin during the writing in the lower information layer 8.

According to a modification of the preferred embodiment, a transmission map indicating one or more written portions of the upper information layer 6 can be determined, for example by the control unit 36, before or during the recording operation. The transmission map of written portions could then be combined or “convoluted” with the header areas H or portions determined, that is, if the dual layer disk 1 contains such headers (which is not necessarily the case as indicated in the introductory description), and the positions of other large gap portions (e.g. linking gaps ). Then, a correction due to a displacement determined between the two information layers 6, 8 can be performed to obtain a detailed final transmission map.

The transmission map can be determined on the basis of a table of contents (TOC) of the upper information layer 6. If data erased from the TOC is only made unaccessible but not actually erased from the upper information layer 6, there is a need for an extended TOC that also contains information on where data was written before even though this data is no longer accessible logically. As an alternative, the transmission map could be obtained or generated on the basis of a pre-scanning operation in order to find the locations in the lower information layer 8 which are affected by the transmission or transmittivity state of the upper information layer 6. This pre-scanning operation could be a quick scan operation during which only every N tracks in the upper information layer 6 are scanned. The number N can be chosen from a range given by the following equation:

N·tₚ≈0.5·d_{b}. . . 1.0d_{b}

where tₚ denotes the track pitch and d_{b} denotes the diameter of the recording beam in the upper information layer 6.

Thus, the transmission map shows the effects of the written portions (and header areas and/or gap portions) of the upper information layer 6 on the lower information layer 8, that is, a map of “shadow” regions due to different transmittivities. Based on this transmission map easy control of the recording power, for example, using a wobble counter to derive the recording position can be implemented. Furthermore, in cases where not the whole area of the upper layer is written, there will be boundary zones in which the “blocking factor”, that is, the degree of reduction in transmittivity or transmission of the upper layer, continuously differs. If the state of the whole upper layer is known, this knowledge can be incorporated in or calculated from the transmission map so as to provide a gradual adaptation of the recording power in such boundary zones.

It is to be noted that the present invention is not restricted to the above preferred embodiment but can be used in any recording method for recording on a multilayer record carrier where the recording operation on one of the information layers is influenced by differences in a transmission property of the other information layer or layers. In particular, there are a large number of possibilities in the optical design of information layers. Usually, information layers are made which have a high initial reflection and a lower reflection in the written state. However, it is also possible to use information layers with the opposite contrast, that is, so-called “white-writing” layers. Similarly, the transmittivity of the written state may be lower than that of the un-written state due to an alternative information layer design. Thus, the preferred embodiment may vary within the scope of the appended claims. Furthermore, the word “comprise” and its conjugations do not exclude the presence of steps or elements other than those listed in the claims. In the claims, any reference sign placed between parentheses shall not be construed as limiting the claims.

1. A method of recording information on a multilayer record carrier (1) by irradiating the record carrier by a radiation beam having a recording power, said multilayer record carrier comprising at least two substantially parallel information layers (6, 8), said method comprising the steps of:
a) a detecting a difference in a transmission property of at least one (6) of said at least two information layers (6, 8);
b) determining, on the basis of said detected difference in a transmission property, a corrected value for a recording power used for recording said information, and
c) using said corrected value for recording said information on another one (8) of said at least two information layers (6, 8) when said recording is effected through said at least one (6) of said at least two information layers (6, 8) at a position where said difference in a transmission property has been detected.

2. A method as claimed in claim 1, wherein said record carrier (1) is a writable optical disk and said at least one information layer (6) is a semi-transparent layer.

3. A method as claimed in claim 1 or 2, wherein said difference in the transmission property is obtained by determining a portion of said at least one recording layer (6) which contains recorded data.

4. A method as claimed in any one of the preceding claims, in which said corrected value is determined by measuring the reflection level difference in said other information layer (8) when said recording is effected through a recorded area or through a non-recorded area of said at least one information layer (6).

5. A method as claimed in any one of the preceding claims, also comprising the step of using a power correction procedure provided in a recording apparatus for correcting said recording power according to said corrected value.

6. A method as claimed in claim 5, in which said corrected value is used as a pre-set value for said power correction procedure at said position where said difference has been detected.

7. A method as claimed in claim 1 or 2, also comprising the steps of:
i) determining a first angular offset between header areas on said at least one (6) information layer and header areas on said other information layer (8) by measuring differences in the reflection level in said other information layer (8) caused by said header areas in said at least one information layer (6) at a predetermined first measuring point;
j) deriving positions of header areas from said first angular offset determined; and
k) using said corrected value at said derived header positions.

8. A method as claimed in claim 7, also comprising the step of determining a second angular offset between header areas on said at least one (6) information layer and header areas on said other information layer (8) by measuring differences in the reflection level in said other information layer (8) caused by said header areas in said at least one information layer (6) at a second predetermined measuring point located at a radius of said record carrier (1) different from that of the first predetermined measuring point, the header areas being derived from both the first angular offset and the second angular offset so as to account for a possible decentering of said at least two information layers (6, 8).

9. A method as claimed in claim 7 or 8, in which said corrected value is determined on the basis of said measured reflection level differences.

10. A method as claimed in claims 1, 2, 7 or 8, in which said corrected value is determined by performing a trial recording during which test patterns are recorded on the record carrier.

11. A method as claimed in claim 1, also comprising the step of reading a corresponding specification provided on said record carrier (1) from said record carrier, and in which said corrected value is determined from the corresponding specification read.

12. A method as claimed in claim 1, in which said difference in said transmission property is obtained on the basis of a transmission map indicating recorded portions of said at least one information layer (6).

13. A method as claimed in claim 12, in which said difference in said transmission property is obtained on the basis of said transmission map combined with positions of header areas (H) or gap portions.

14. A method as claimed in claim 12 or 13, wherein said transmission map is corrected on the basis of a determined displacement between said at least two information layers (6, 8).

15. A method as claimed in any one of claims 12 to 14, wherein said transmission map is derived from a table of contents comprising information about the position of information recorded on said at least one information layer (6).

16. A method as claimed in any one of claims 12 to 14, comprising the step of pre-scanning the record carrier, said transmission map being derived from the pre-scanning operation.

17. A method as claimed in claim 16, wherein said pre-scanning operation is a quick scan operation in which only every N tracks of said at least one recording layer (6) are scanned so as to determine the transmission states of the at least one information layer (6).

18. A recording apparatus for recording information on a multilayer record carrier (1) provided with at least two substantially parallel information layers (6, 8), said apparatus comprising:
a recording unit (10) for recording said information with a predetermined recording power, and
determining means (17) for determining a difference in a transmission property of at least one (8) of said at least two information layers (6, 8),
wherein said recording unit (10) is controlled to perform said recording with a corrected value of the recording power when said recording is effected on another one (8) of said at least two information layers (6, 8) through said at least one information layer (6) at a position where said difference has been detected.

19. An apparatus as claimed in claim 18, wherein said determining means is an optical detection system (17) for detecting light reflected at said at least one information layer (6).

20. An apparatus as claimed in any one of claims 18 to 19, wherein said control of the recording unit to perform said recording with a corrected value of the recording power is carried out by a power calibration function of said recording apparatus.

21. An apparatus as claimed in any one of claims 18 to 20, wherein said determining means is arranged to obtain a transmission map indicating recorded portions of said at least one information layer (6) on the basis of a pre-scanning operation.

22. An apparatus as claimed in any one of claims 18 to 20, wherein said determining means is arranged to obtain a transmission map indicating recorded portions of said at least one information layer (6) on the basis of a table of contents comprising information about the position of information recorded on said at least one information layer (6).

23. An apparatus as claimed in any one of claims 18 to 22, wherein said recording apparatus is an optical disk recording device.

24. A multilayer record carrier (1) provided with at least two substantially parallel information layers (6, 8) and suitable to be recorded by a single recording unit (10), wherein a specification is provided on said record carrier (1), said specification indicating a power correction factor to be used when recording is effected on one (8) of said at least two information layers (6, 8) through another one (6) of said at least two information layers (6, 8).

25. A multilayer record carrier as claimed in claim 24, said multilayer record carrier being a rewritable optical disk (1).
